(19) United States
(12) Patent Application Publication
(10) Pub. No.: US 2011/0054216 A1
(43) Pub. Date: Mar. 3, 2011

(54) NOVEL PROCESS FOR MAKING (2R)-(3-AMINO-2-FLUOROPROPYL)PHOSPHINIC ACID FORM A

(76) Inventors: Hassan Abbasi, Sodertalje (SE); Daniel Finnhult, Sodertalje (SE); Ann-Sofie Krig, Sodertalje (SE); Lars Lilljequist, Sodertalje (SE); Karin Lundblad, Sodertalje (SE); Mikaela Recknagel, Sodertalje (SE); Anna Stenemyr, Sodertalje (SE); Erica Tjerneld, Sodertalje (SE)

(21) Appl. No.: 12/922,468

(22) PCT Filed: Dec. 18, 2008
(86) PCT No.: PCT/SE2008/051491

§ 371 Date: Sep. 14, 2010

Related U.S. Application Data
(60) Provisional application No. 61/015,757, filed on Dec. 21, 2007.

(51) Int. Cl. C07F 9/30

(52) U.S. Cl. 564/15

(57) ABSTRACT

The present invention is directed to a novel process for the preparation of the crystalline form A of (2R)-(3-amino-2-fluoropropyl)phosphinic acid.

### FIELD OF THE INVENTION

The present invention is directed to a novel process for the preparation of the crystalline form A of (2R)-(3-amino-2-fluoropropyl)phosphinic acid.

### BACKGROUND

A crystalline form of the compound (2R)-(3-amino-2-fluoropropyl)phosphinic acid is described as Example 5 in EP-B1 1240172. It is prepared by reacting ammonium hypophosphite with tert-butyl (2R)-2-fluoro-3-iodopropyl carbamate in the presence of N,O-bis-(trimethylsilyl)acetamide.

The present invention pertains to the preparation of (2R)-(3-amino-2-fluoropropyl)phosphinic acid form A using the process as is outlined below.

### DESCRIPTION OF THE INVENTION

One aspect of the present invention is to provide a process for preparing (2R)-(3-amino-2-fluoropropyl)phosphinic acid form A having an X-ray powder diffraction pattern essentially as shown in FIG. 2, comprising the sequential steps of:
a. treating (2R)-3-[(tert-butoxycarbonyl)amino]-2-fluoropropylphosphinic acid ammonium salt with an acid in a polar solvent;
b. adjusting the pH to between 5-6 and optionally removing formed inorganic salts; and
c. adding an anti-solvent or a mixture thereof and optionally cooling and optionally isolating the product.

In another embodiment, the acid is sulphuric acid.

In another embodiment, said polar solvent is methanol or isopropanol.

In another embodiment, step a is carried out at a temperature of from 50° C. to 60° C.

The pH may be adjusted to between 5-6 using e.g. a base, a HCl consuming reagent or by ion exchanger. One example of such a HCl consuming reagent is propylene oxide. One example of such an ion exchanger is Dowex® 50WX-8-200 (H⁺ form).

In another embodiment, a base is used in step b.

In another embodiment, said base is NH₃ or ammonium acetate.

In another embodiment, said anti-solvent is acetonitrile, acetone, ethanol, isopropanol, ethyl acetate, or mixtures thereof.

In another embodiment, the product of step c is dissoluted in a polar solvent and recrystallized in an anti-solvent.

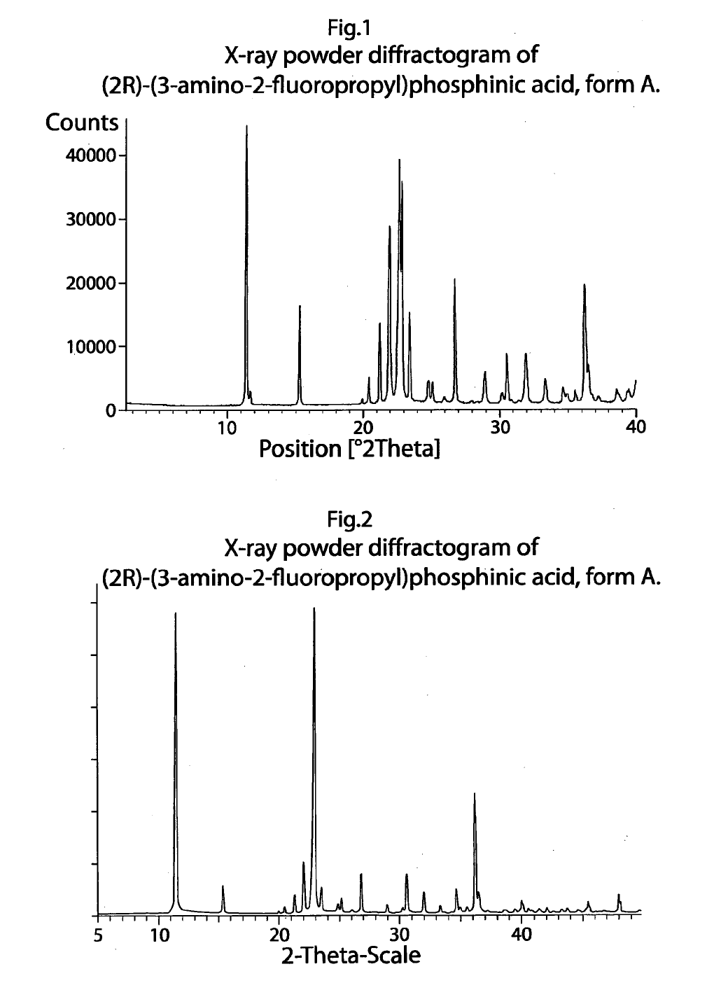

FIG. 1 is an X-ray powder diffractogram of (2R)-(3-amino-2-fluoropropyl)phosphinic acid in a crystalline form, hereinafter referred to as (2R)-(3-amino-2-fluoropropyl)phosphinic acid form A.

(2R)-(3-amino-2-fluoropropyl)phosphinic acid form A is characterized in providing an X-ray powder diffraction (XRPD) pattern, exhibiting substantially the following peaks with d-values (d-value: the spacing between successive parallel hkl planes in a crystal lattice).

Form A

| | Relative |
|---|---|
| d-value (Å) | Intensity |
| 7.8 | vs |
| 7.6 | w |
| 5.8 | m |
| 4.44 | vw |
| 4.34 | w |
| 4.18 | s |
| 4.04 | s |
| 3.91 | s |
| 3.88 | vs |
| 3.79 | m |
| 3.58 | w |
| 3.54 | w |
| 3.43 | vw |
| 3.32 | m |
| 3.08 | w |
| 2.96 | vw |
| 2.92 | m |
| 2.80 | m |
| 2.69 | w |
| 2.59 | w |
| 2.57 | w |
| 2.53 | w |
| 2.48 | s |
| 2.46 | w |
| 2.41 | vw |
| 2.33 | vw |
| 2.28 | vw |

The relative intensities are presented by the following definitions.

| Definitions used | % Relative Intensity |
|---|---|
| vs (very strong): | 100-70 |
| s (strong): | 70-40 |
| m (medium): | 40-10 |
| w (weak): | 10-5 |
| vw (very weak): | <5 |

The relative intensities were derived from diffractograms measured with variable slits.

The peaks, identified with d-values calculated from the Bragg formula and intensities, have been extracted from the diffractogram of (2R)-(3-amino-2-fluoropropyl)phosphinic acid form A. Additional peaks can be extracted, using conventional methods, from the diffractogram. The presence of these peaks is sufficient to establish the presence of said different polymorphs of crystalline (2R)-(3-amino-2-fluoropropyl)phosphinic acid. Merely loss of a peak does not mean that another crystalline form of the compound has been obtained.

(2R)-(3-amino-2-fluoropropyl)phosphinic acid form A is further characterized by an X-ray powder diffraction pattern essentially as shown in FIG. 1.

(2R)-(3-amino-2-fluoropropyl)phosphinic acid form A, i.e. the compound of the present invention, may be crystallized in one single solvent or in a mixture of solvents. Crystallization may be initiated or effected with or without seeding with crystals of the is compound of the invention.

(2R)-(3-amino-2-fluoropropyl)phosphinic acid form A according to the present invention is substantially free from other crystal and non-crystal forms of (2R)-(3-amino-2-fluoropropyl)phosphinic acid. The term “substantially free from other crystal and non-crystal forms of (2R)-(3-amino-2-fluoropropyl)phosphinic acid” shall be understood to mean that the desired crystal form of (2R)-(3-amino-2-fluoropropyl)phosphinic acid form A contains less than 15%, such as less than 10%, or less than 5% of any other forms of (2R)-(3-amino-2-fluoropropyl)phosphinic acid.

### Methods of Preparation

(2R)-(3-amino-2-fluoropropyl)phosphinic acid form A may be prepared by dissolving of (2R)-3-[(tert-butoxycarbonyl)amino]-2-fluoropropylphosphinic acid ammonium salt in a polar solvent, for example methanol or isopropanol, and treatment of the solution with an acid at an elevated temperature, for example at a temperature of from 50-60° C. The reaction mixture is cooled to 30° C. and pH is adjusted to 5-6 by addition of a base. Inorganic salts may form which are precipitated and removed.

Crystallisation of (2R)-(3-amino-2-fluoropropyl)phosphinic acid may be initiated by adding an anti-solvent or a mixture of anti-solvents, for example acetonitrile, acetone, ethanol, isopropanol or ethyl acetate at an elevated temperature, for example at a temperature of from 40-70° C. The slurry is cooled and formed crystals are isolated and dried.

(2R)-(3-amino-2-fluoropropyl)phosphinic acid is a zwitterion, that may be crystallised at the isoelectric point, in this case approximately at a pH of 5.3. As the reaction is performed during acidic conditions, the protonated species of (2R)-(3-amino-2-fluoropropyl)phosphinic acid is formed. After completed reaction, the pH is adjusted to 5-6 by addition of a base in order to isolate (2R)-(3-amino-2-fluoropropyl)phosphinic acid crude as the zwitterion. The solution of (2R)-(3-amino-2-fluoropropyl)phosphinic acid works as a buffer solution and the amount of base added to reach the set pH-interval (5-6) is can be varied in the range of from 1.8-2.8 equivalents.

A solute is crystallized from a primary solvent by the addition of a second solvent “anti-solvent” in which the solute is relatively insoluble. The anti-solvent is miscible with the primary solvent and brings about a solubility decrease of the solute in the resulting binary solvent mixture (see e.g. Allan S. Myerson, Handbook of Industrial Crystallization, second edition).

Bases useful for pH adjustment is for example NH₃ in methanol or ammonium acetate dissolved in methanol.

The formed crystals of (2R)-(3-amino-2-fluoropropyl)phosphinic acid form A may be recrystallised by dissolution in a polar solvent or a mixture of polar solvents such as methanol, isopropanol or water or a mixture thereof. The solution is clear filtered and the filter is washed with the polar solvent used. The temperature is kept at room temperature, and an anti-solvent or a mixture of anti-solvents, for example acetonitrile, acetone, ethanol, isopropanol, ethyl acetate or a mixture thereof are added during a period of 2 to 5 hours.

The slurry is then stirred 5 to 12 hours. The formed product is filtered off and washed with the used anti-solvent and dried in vacuum.

The invention is illustrated, but not limited, by the following examples.

### EXAMPLES

### General Methods

¹H-NMR was performed on a Brucker 400 MHz spectrometer with D₂O as reference.

X-ray powder diffraction analysis (XRPD) was performed on samples prepared according to standard methods, for example those described in Giacovazzo, C. et al (1995), Fundamentals of Crystallography, Oxford University Press; Jenkins, R. and Snyder, R. L. (1996), Introduction to X-Ray Powder Diffractometry, John Wiley & Sons, New York; is Bunn, C. W. (1948), Chemical Crystallography, Clarendon Press, London; or Klug, H. P. & Alexander, L. E. (1974), X-ray Diffraction Procedures, John Wiley and Sons, New York. X-ray diffraction analyses were performed using a PANalytical X′Pert Pro MPD for 96 minutes from 1 to 60° 2θ with CuKα radiation. Calculation into d-values (distance values) was done and they may vary in the range±2 on the last given decimal place.

It will be appreciated by a skilled person in the art that XRPD intensities may vary when measured for essentially the same crystalline form, for example, preferred orientation.

As used herein,

Tᵢ refers to inner temperature,
T_{J} refers to jacket temperature.

### Example 1

### Preparation of (2R)-(3-amino-2-fluoropropyl)phosphinic acid form A

1 g (2R)-3-[(tert-butoxycarbonyl)amino]-2-fluoropropylphosphinic acid ammonium salt (mw=258.2 g/mole) was treated with sulphuric acid (0.47 g, 2 equiv. conc. H₂SO₄) in 10 ml isopropanol at 50° C. After removal of the tert-butoxycarbonyl-group (BOC-group), the slurry was dried and 10 ml methanol was added at 50° C. The pH was adjusted to 5-6 with NH₃ in methanol. During the pH-adjustment ammonium sulphate and other salts precipitated. The solid material was filtered off and (2R)-(3-amino-2-fluoropropyl)phosphinic acid was crystallized from the methanol solution by addition of 10 ml isopropanol. The obtained crystals was isolated by filtration, washed and dried. The yield was 87.9%.

¹H-NMR (400 MHz, D₂O): δ 1.93 (1H, m), 2.13 (1H, m), 3.31 (2H, m), 5.14 (1H, dm, J=50 Hz), 7.07 (1H, d, J=528 Hz).

The crystals were analysed by X-ray powder diffraction (XRPD), see FIG. 1. The diffractogram of form A shows the following d-values given in Angstrom and relative intensities:

Form A

| | Relative |
|---|---|
| d-value (Å) | Intensity |
| 7.8 | vs |
| 7.6 | w |
| 5.8 | m |
| 4.44 | vw |
| 4.34 | w |
| 4.18 | s |
| 4.04 | s |
| 3.91 | s |
| 3.88 | vs |
| 3.79 | m |
| 3.58 | w |
| 3.54 | w |
| 3.43 | vw |
| 3.32 | m |
| 3.08 | w |
| 2.96 | vw |
| 2.92 | m |
| 2.80 | m |
| 2.69 | w |
| 2.59 | w |
| 2.57 | w |
| 2.53 | w |
| 2.48 | s |
| 2.46 | w |
| 2.41 | vw |
| 2.33 | vw |
| 2.28 | vw |

The relative intensities are presented by the following definitions.

| Definitions used | % Relative Intensity |
|---|---|
| vs (very strong): | 100-70 |
| s (strong): | 70-40 |
| m (medium): | 40-10 |
| w (weak): | 10-5 |
| vw (very weak): | <5 |

The relative intensities were derived from diffractograms measured with variable slits.

### Example 2

### Preparation of (2R)-(3-amino-2-fluoropropyl)phosphinic acid form A

320 g (1.11 moles) (2R)-3-[(tert-butoxycarbonyl)amino]-2-fluoropropylphosphinic acid ammonium salt dissolved in methanol (960 ml, 23.72 moles) was treated with sulphuric acid (105.43 ml, 1.90 moles) at 55° C. After complete reaction, the reaction mixture was cooled to 30° C. and pH was adjusted to approximately 5 by addition of ammonium acetate dissolved in methanol (180 g, 2.34 moles, 420 ml methanol). During the pH-adjustment is ammonium sulphate and remaining ammonium acetate and other salts precipitated. The neutralised reaction mixture was clear filtrated. Isopropanol (3.84 L, 50.23 moles) was added at 50° C. and (2R)-(3-amino-2-fluoropropyl)phosphinic acid form A, crystallised. The slurry was cooled to 0° C. The crystals were isolated and dried under vacuum.

¹H-NMR (400 MHz, D₂O): δ 1.93 (1H, m), 2.13 (1H, m), 3.31 (2H, m), 5.14 (1H, dm, J=50 Hz), 7.07 (1H, d, J=528 Hz).

### Example 3

### Recrystallisation of (2R)-(3-amino-2-fluoropropyl)phosphinic acid form A

To 63.90 g (0.4248 moles) of (2R)-(3-amino-2-fluoropropyl)phosphinic acid (crude form A) was added to a mixture of 149 mL of methanol (2.48 rel vol) and 90 mL of water (1.5 rel vol). The reaction mixture was heated to 35° C. A clear solution was obtained. The solution was clear filtered and the filter was washed with methanol (61 ml, 1.02 rel vol). After filtration the solution was cooled to 25° C. The temperature was then kept at 25° C., and 480 mL (8 rel vol) of acetone was added over 3 hours and 20 minutes. The slurry was stirred at 25° C. for 5 hr before filtration. The product was filtered off and washed with acetone (240 ml, 4 rel vol), and dried in vacuum at 40° C. until the total amount of solvents were shown to be >1% (w/w) by thermogravimetric analysis. 58.3 g of (2R)-(3-amino-2-fluoropropyl)phosphinic acid was obtained after drying.

¹H-NMR (400 MHz, D₂O): δ 1.93 (1H, m), 2.13 (1H, m), 3.31 (2H, m), 5.14 (1H, dm, J=50 Hz), 7.07 (1H, d, J=528 Hz).

### Example 4

### Process Example 1

### Formation of (2R)-(3-amino-2-fluoropropyl)phosphinic acid form A

To a slurry of 450 kg (258.2 g/mole, 1.74 kmoles; weight at 100% assay) (2R)-3-[(tert-butoxycarbonyl)amino]-2-fluoropropylphosphinic acid ammonium salt in methanol (889 kg, 1125 L, 2.5 rel. vol.), concentrated sulphuric acid (230 kg, 2251 moles, 1.3 eqv.) was added over a period of 60 minutes while keeping Tᵢ=55±3° C. After the addition, the reaction mixture was heated to 62±3° C. and kept for 25 hours. After complete conversion the solution was cooled to 30±5° C., whereupon approximately 1 rel. vol. (355 kg, 450 L) was distilled off under reduced pressure (T_{J}=60° C.). Methanol (357 kg, 450 L, 1 rel. vol.) was added to the reaction slurry.

pH was adjusted to 5-6.2 by an addition of ammonium acetate (228 kg, 1.7 eqv.) dissolved in methanol (533 kg, 675 L, 1.5 rel. vol.). The addition is exotherm, why it is added over at least 30 minutes. After the additon the slurry was stirred for 30 minutes, precipitated salts were filtered off and the resulting filter cake was washed with methanol (533 kg, 675 L, 1.5 rel. vol.). The filtration must be performed within 3 hours to avoid precipitation of the title compound and a loss in yield as a result.

The filtered solution was concentrated to 650 L (1.4 rel. vol.) under reduced pressure (T_{J}=60° C.). The resulting oil was temperature adjusted to 50° C. and seeded with crystals of the product from Example 3 (0.74 kg, 0.003 eqv.), whereupon ethanol (1067 kg, 1350 L, 3 rel. vol.) was charged over a period of 30 minutes. The slurry was aged for 1 hour, whereupon ethyl acetate (1412 kg, 1587 L, 3.5 rel. vol.) was added over a period of 30 minutes. The slurry was stirred at 50° C. for 15 minutes and then cooled to 0° C. over a is period of 5 hours. After 1 hour at 0° C. the precipitated product was isolated and washed with a mixture of ethanol (356 kg, 450 L, 1 rel. vol.) and ethyl acetate (405 kg. 450 L, 1 rel. vol.). The isolated product was dried under vacuum at T_{J}=40° C. (246 kg, 87%).

¹H-NMR (400 MHz, D₂O (4.7 ppm)): δ 1.83 (1H, m), 2.04 (1H, m), 3.22 (2H, m), 5.04 (1H, dm, J=49 Hz), 6.97 (1H, d, J=528 Hz).

### Example 5

### Process Example 2

### Formation of (2R)-(3-amino-2-fluoropropyl)phosphinic acid form A

246.5 kg (141.07 g/moles, 1.51 kmoles (2R)-(3-amino-2-fluoropropyl)phosphinic acid (crude) was elutriated in isopropanol (779 kg, 986 L, 4 rel. vol.) at 50° C. for 1.5 hours. The product was isolated, washed with isopropanol (487 kg, 616 L, 2.5 rel. vol.) and dried under vacuum at T_{J}=45° C. (215 kg, 97%).

¹H-NMR (400 MHz, D₂O (4.7 ppm)): δ 1.85 (1H, m), 2.05 (1H, m), 3.23 (2H, m), 5.06 (1H, dm, J=49 Hz), 6.99 (1H, d, J=528 Hz).

### Example 6

### Process Example 3

### Formation of (2R)-(3-amino-2-fluoropropyl)phosphinic acid form A

291 kg (141.07 g/moles, 2.06 kmoles, weight at 100% assay) of (2R)-(3-amino-2-fluoropropyl)phosphinic acid was dissolved in water (435 kg, 435 L, 1.5 rel. vol.) and methanol (573 kg, 725 L, 2.5 rel. vol.) at 35° C. After 25 minutes the solution was clear filtrated and the filter was washed with methanol (229 kg, 290 L, 1 rel. vol). The solution was cooled to 25° C., followed by an addition of acetone (1833 kg, 2320 L, 8 rel. vol.) over a period of 3.5 hours. After 5 hours at 25° C. the product was isolated and washed with acetone (916 kg, 1160 L, 4 rel. vol.). The isolated material was dried under vacuum at T_{J}=40° C. (259 kg, 87%).

¹H-NMR (600 MHz, D₂O (4.7 ppm)): δ 1.87 (1H, m), 2.08 (1H, m), 3.25 (2H, m), 5.09 (1H, dm, J=49 Hz), 7.01 (1H, d, J=527 Hz).

The crystals were analysed by X-ray powder diffraction (XRPD), see FIG. 2. The diffractogram of form A shows the following d-values given in Angstrom and relative intensities:

Form A

| | Relative |
|---|---|
| d-value (Å) | Intensity |
| 7.8 | vs |
| 7.6 | w |
| 5.8 | m |
| 4.44 | vw |
| 4.34 | vw |
| 4.18 | w |
| 4.04 | m |
| 3.91 | m |
| 3.88 | vs |
| 3.79 | w |
| 3.58 | vw |
| 3.54 | w |
| 3.43 | vw |
| 3.32 | m |
| 3.08 | vw |
| 2.96 | vw |
| 2.92 | m |
| 2.80 | w |
| 2.69 | vw |
| 2.59 | w |
| 2.57 | vw |
| 2.53 | vw |
| 2.48 | m |
| 2.46 | w |
| 2.41 | vw |
| 2.33 | vw |
| 2.28 | vw |

The relative intensities are presented by the following definitions.

| Definitions used | % Relative Intensity |
|---|---|
| vs (very strong): | 100-70 |
| s (strong): | 70-40 |
| m (medium): | 40-10 |
| w (weak): | 10-5 |
| vw (very weak): | <5 |

1. A process for preparing (2R)-(3-amino-2-fluoropropyl)phosphinic acid form A having an X-ray powder diffraction pattern essentially as shown in FIG. 2, comprising the sequential steps of:
a. treating (2R)-3-[(tert-butoxycarbonyl)amino]-2-fluoropropylphosphinic acid ammonium salt with an acid in a polar solvent;
b. adjusting the pH to between 5-6 and optionally removing formed inorganic salts; and
c. adding an anti-solvent or a mixture thereof and optionally cooling and optionally isolating the product.

2. The process according to claim 1, wherein the acid is sulphuric acid.

3. The process according to claim 1 or 2, wherein said polar solvent is methanol or isopropanol.

4. The process according to any one of claims 1 to 3, wherein step a is carried out at a temperature of from 50° C. to 60° C.

5. The process according to any one of claims 1 to 4, wherein a base is used in step b.

6. The process according to claim 5, wherein said base is NH₃ or ammonium acetate.

7. The process according to any one of claims 1 to 6, wherein said anti-solvent is acetonitrile, acetone, ethanol, isopropanol, ethyl acetate, or mixtures thereof.

8. The process according to any one of claims 1 to 7, wherein the product of step c is dissoluted in a polar solvent and recrystallized in an anti-solvent.
